(19) United States
(12) Patent Application Publication
(10) Pub. No.: US 2009/0205571 A1
(43) Pub. Date: Aug. 20, 2009

(54) FORMICARIA FOR TRACKING ANT ACTIVITY

(76) Inventor: Gary Armstrong, Seattle, WA (US)

Correspondence Address: ROBERT W. J. USHER;PATENT AGENT, 1133 BROADWAY, #1515, NEW YORK, NY, 10010, US

(21) Appl. No.: 12/099,597

(22) Filed: Apr. 8, 2008

Related U.S. Application Data
(60) Provisional application No. 61/028,528, filed on Feb. 14, 2008.

(51) Int. Cl. A01K 29/00

(52) U.S. Cl. 119/6.5

(57) ABSTRACT

A formicarium housing is filled with discrete layers of sand of respectively different colors bound together by ant nutritious sugar deposited from solution saturating the sand so that ants can tunnel through the particulate material depositing tailings of different colors on a top surface of the material displayed in an order corresponding to an order of the regions in which the ants have been tunneling. A formicarium kit has an ant proof, transparent walled housing, clear plastic packets of respectively differently colored sands, a mixing cup, a stirrer, and sugar packets.

### RELATED APPLICATIONS

Priority is claimed from my provisional application 61/028528 filed Feb. 14, 2008, the disclosure of which is incorporated herein by reference.

### FIELD OF THE INVENTION

The invention relates to formicaria and more particularly to formicaria for tracking the order of ant tunneling activity.

### BACKGROUND OF THE INVENTION

Formicaria have been employed for studying ant behaviour for many years. Although the tunnels and tailings do provide some record of ant activity, even if all tunnels can be observed, it can be difficult to track such tunneling activity without constant surveillance which is often inconvenient or impracticable, particularly in respect of the ants' nocturnal activities. In particular, when a plurality of tunnels are dug outside a surveillance period, such as overnight, the order in which the particular tunnels or groups of tunnels are dug and the specific origins/regions of the materials may not be determinable retrospectively.

### OBJECTS OF THE INVENTION

It is one object of the invention to provide a formicarium which facilitates restrospective tracking of ants' tunneling activities, in particular, the order of activity occurring outside a period of surveillance, such as overnight, and the origins of the materials used.

According to one aspect, the invention provides a formicarium comprising an ant proof housing with a transparent side wall portion and a partial filling of differently colored, ant tunneling material forming contiguous regions of respectively different colors through which the ants can tunnel so that the tailings are displayed on a top surface of the material, indicative of the order of tunneling.

Some particulate materials, such as some of those for use in ant farms marketed by Uncle Milton Industries, Westlake Village, Calif. are relatively light and fluffy with a ‘self-binding’ property so as to temporarily bind or hold together sufficiently, without use of a binder, to avoid immediate back-filling preventing ant tunnel formation, whereas sands require an additional binder to bind the particles together sufficiently to prevent back-fill and enable tunneling.

The regions having different colors from each other may be formed as distinct layers or strata extending generally horizontally at different levels.

Preferably, an ant food is provided in the housing.

When the ant tunneling material comprises sand, the ant food may be sugar residue from a solution in water with which the sand has been saturated and also providing the binder.

A record of the ants' activities in one or more particular regions will be evident from the colors of the tailings. For example, when ants are tunneling in differently colored regions generally simultaneously, the corresponding region or stratum of tailings will be an amorphous mixture of the colors of the tunneled regions and when the ants are tunneling predominately in a region of only a single color, the corresponding region or stratum of tailings will be of that color. The order of region tunneling will be reflected by the order of the layers of tailings deposited on the top of the tunneling material.

According to another aspect, the invention provides a method for making a formicarium comprising the steps of:

providing an ant proof housing with a transparent side wall portion;

providing ant tunneling material of respectively different colors;

depositing the ant tunneling material into the housing to form contiguous regions of respectively different colors so that ants can tunnel through the regions depositing tailing layers of different colors on a top surface of the material in an order corresponding to an order of the regions in which the ants have been tunneling and seen through the transparent side wall portion. The contiguous regions having different colors from each other may be deposited as respective distinct layers extending horizontally at respective different levels.

The ant tunneling material may comprise sand and a binder added to the sand after deposition thereof as contiguous regions, thereby binding the sand.

The ants tailings form attractive color displays of ant art and architecture, while the colors of the tailings reveal any particular layer or layers in which the ants have been preferentially tunneling.

Thus, past tunneling activities of the ants can be closely monitored without need for continuous or constant surveillance, particularly advantageous, of course, in tracking the ants' nocturnal activities.

Preferably, the method includes the step of adding a supply of ant food, such as pouring a sugar solution over the sand and permitting to dry so that the sugar residue acts as the binder.

According to another aspect, a kit for assembling a formicarium comprises an ant proof housing with a transparent side wall portion and a plurality of containers each filled with a supply of ant tunneling material of a different color which a user can empty into the housing and form contiguous regions of respectively different colors of ant tunneling material so that ants can tunnel through the ant tunneling material depositing tailing layers of different colors on a top surface of the material in an order corresponding to an order of regions in which the ants have been tunneling and seen through the transparent side wall portion.

In one embodiment, the ant tunneling material includes sand and the kit further comprises a sand binder, preferably an ant food, by which the sand particles are bound together to enable effective ant tunneling.

The ant food may comprise sugar and the kit further comprise a cup and a stirrer so that a user can add water and the sugar to the cup and use the stirrer to dissolve the sugar in the water and then pour the sugar solution from the cup onto sand in the housing to saturate the sand, so that the sugar acts as a binder to enable ant tunneling therethrough. A bottom layer of ant nutritious gel may be provided in the housing.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a photograph of a first embodiment of formicarium according to the invention showing distinct layers of tailings of respectively different colors deposited by tunneling harvester ants over a couple of days;

FIG. 2 is a photograph of a second embodiment of formicarium according to the invention showing distinct layers of tailings of respectively different colors deposited by tunneling harvester ants over a couple of days;

FIG. 3 is a photograph of a third embodiment of formicarium according to the invention showing an amorphous or mixed color layer of tailings deposited over a couple of days;

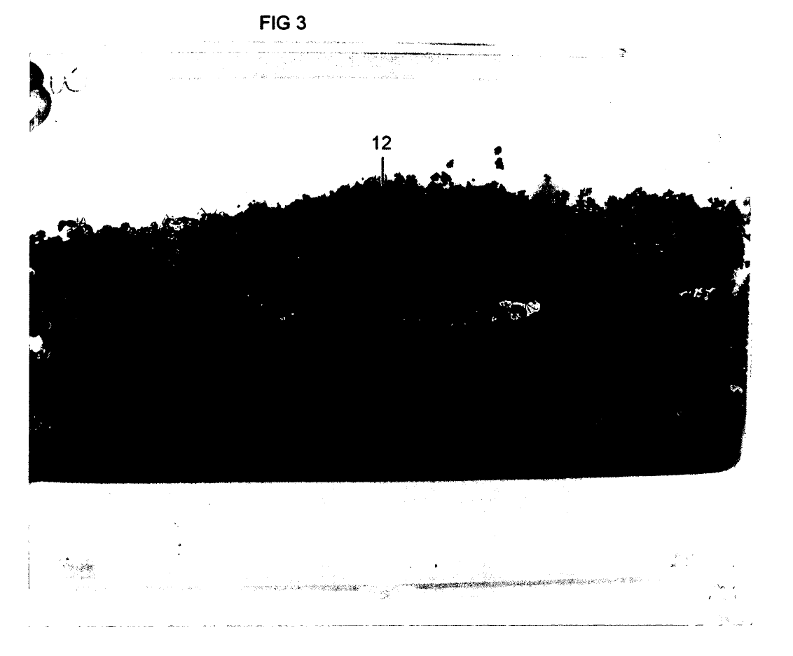

FIG. 4 is a photograph of components of a kit for making a formicarium according to the invention with the housing lid omitted;

FIG. 5 is a photograph of a fourth embodiment of formicarium assembled from the kit of FIG. 4 and before addition of ants; and

FIG. 6 is a photograph of a fifth embodiment of formicarium in which the regions of differently colored sands are located in different volumes of the housing but do not form layers which extend across the entire width of the housing.

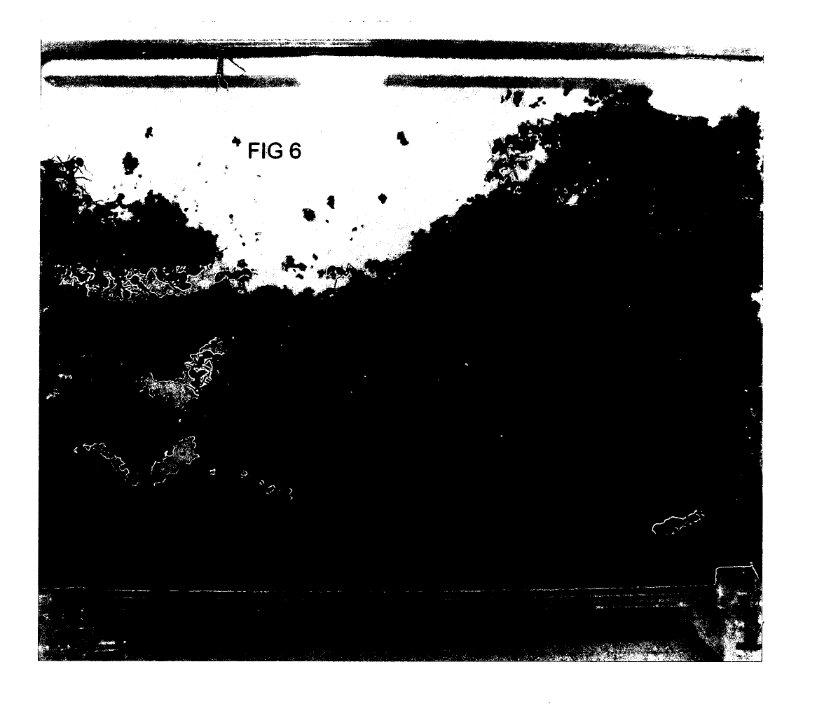

### DESCRIPTION OF PARTICULAR EMBODIMENTS

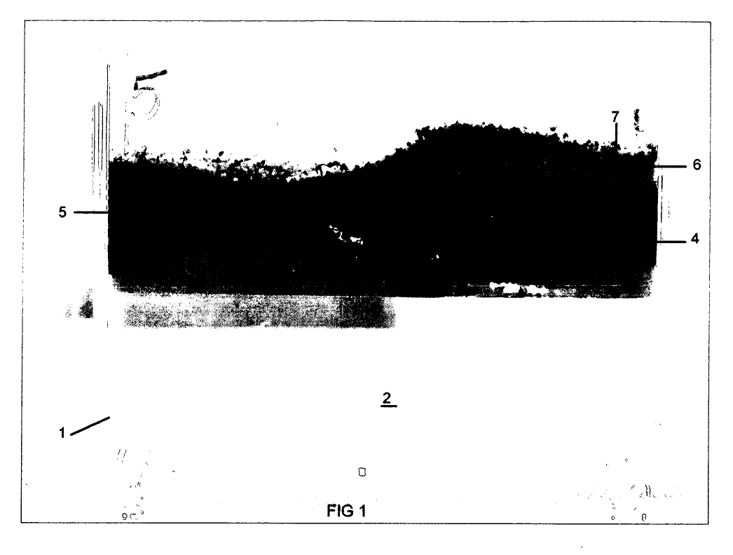

As shown in FIG. 1, a first embodiment of formicarium comprises an ant-proof, housing 1 comprising a base container and a top closure each molded from transparent plastic material with opposed side walls spaced apart at ant tunnel width.

The housing contains a bottom layer 2 of ant nutritious gel; three layers of sand of respectively different colors comprising: a bottom layer 3 of yellow sand deposited by pouring directly on to the gel layer; an intermediate or middle layer 4 of red sand; and a top layer 5 of blue sand. A sugar solution (not seen) has been poured over the sand to saturate the sand, so that sugar residue acts as a binder, after being left for a day or two to dry.

The sand layers form contiguous regions of respectively different colors through which the ants can tunnel so that the tailings are displayed on a top surface of the material.

As can be seen in FIG. 1, a tailings layer 6 of yellow sand has been deposited immediately on top of the top original layer 5 of blue sand, and, on the right hand side a somewhat amorphous or mixed color layer 7 of predominately yellow tailings and red tailings 8 deposited on top of the yellow tailings layer 6. This pattern probably indicates that the majority of initial tunneling activity was concentrated in the bottom layer 3 of yellow sand, followed by more activity in the red intermediated layers 3 and 4, respectively. Of course, the ants needed to initially tunnel through the top layer 5 of blue sand and the intermediate layer 4 of red sand to access the bottom layer 3 of yellow sand so a few particles of red sand are seen to have been deposited on the top surface of the original top blue sand layer 5.

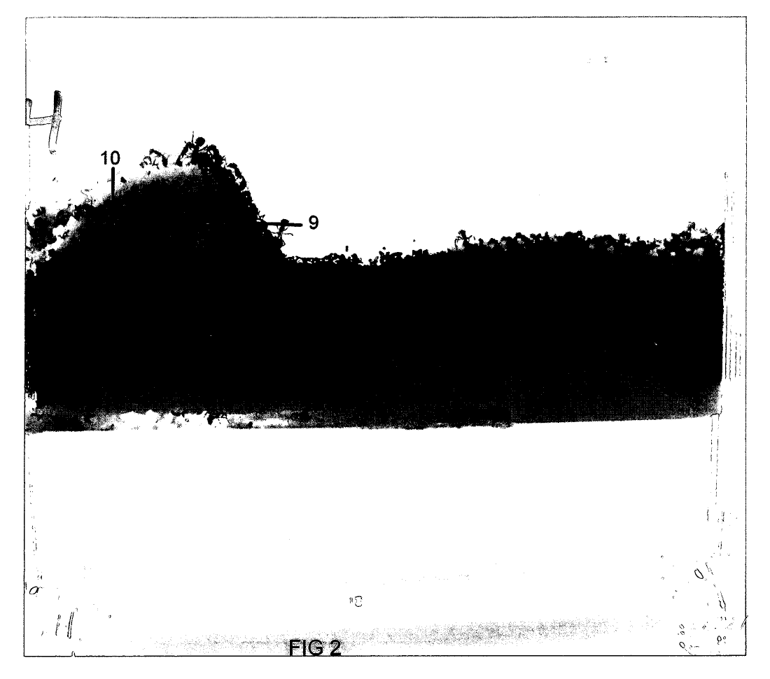

As shown in FIG. 2, in the second embodiment, the sand layers originally deposited are of the same colors as the first embodiment, although of different configurations. As evidenced by the mound of yellow tailings 9 deposited on the blue layer, as with the first embodiment, the majority of initial ant tunneling activity was in the yellow sand with a very thin broken layer of red sand tailings 10 deposited between the yellow tailings layer 9 probably as a result of the need to tunnel firstly through the top blue and intermediate red layers to reach the bottom layer of yellow sand. The ants apparently reached the bottom yellow layer by tunneling vertically down in the left hand corner at 11.

The more amorphous layer of tailings 12 in the third embodiment seems to indicate more evenly distributed tunneling activity simultaneously through all three original sand layers.

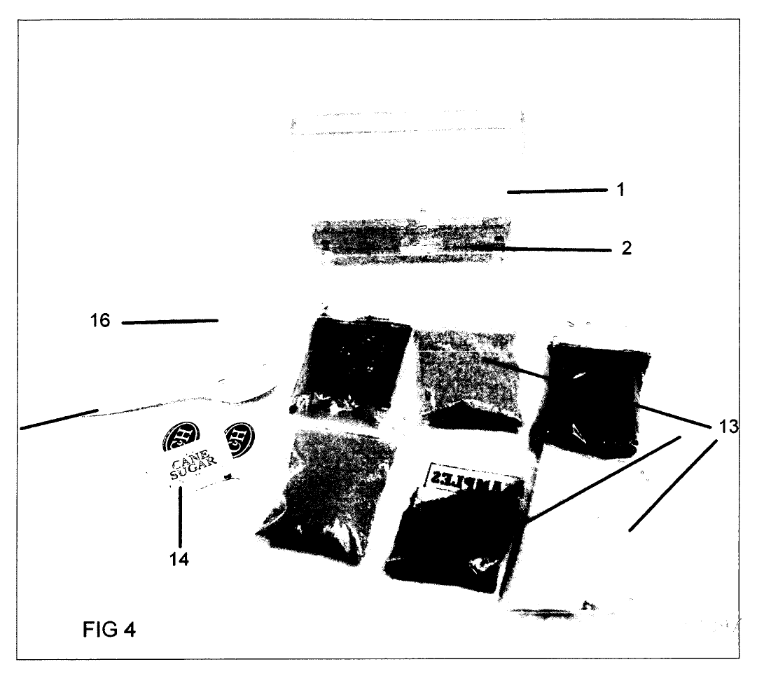

The formicarium kit of FIG. 4, comprises the housing 1, (top closure not shown), in which an ant nutritious gel has been deposited/set as a bottom layer 2; six plastic bags 13, filled with sand of respectively different colors; three packets of sugar 14; a mixing cup 15; and a stirring spoon 16. (The harvester ants are purchased separately.)

The formicarium is assembled by first pouring liquid gel into the housing and allowing to set, pouring the sand from the bags one by one into the housing to form distinct layers of respectively different colors and finally, making a sugar solution by mixing the sugar and water in the cup, pouring over the sand layers so that it is absorbed in the sand, saturating the sand and allowing a day or two to dry.

The sugar (sucrose) residue provides a sand binder to assist in maintaining the integrity of tunnels, for example, to prevent the sand particles from filling back in as the ants try to dig. Antibiotics/fungicides can be added to the gel or sugar solution.

Alternatively, the gel layer may be omitted.

As the customers first fills the empty housing container with the different color sands they can create their own design. Secondly the mixture of nutrients with sugar becomes the ant's food source and finally the mixture that is poured in contains some antibiotics to discourage mold and fungal growth. It becomes interesting to watch the ants dig and bring the different color sands to the top creating different patterns.

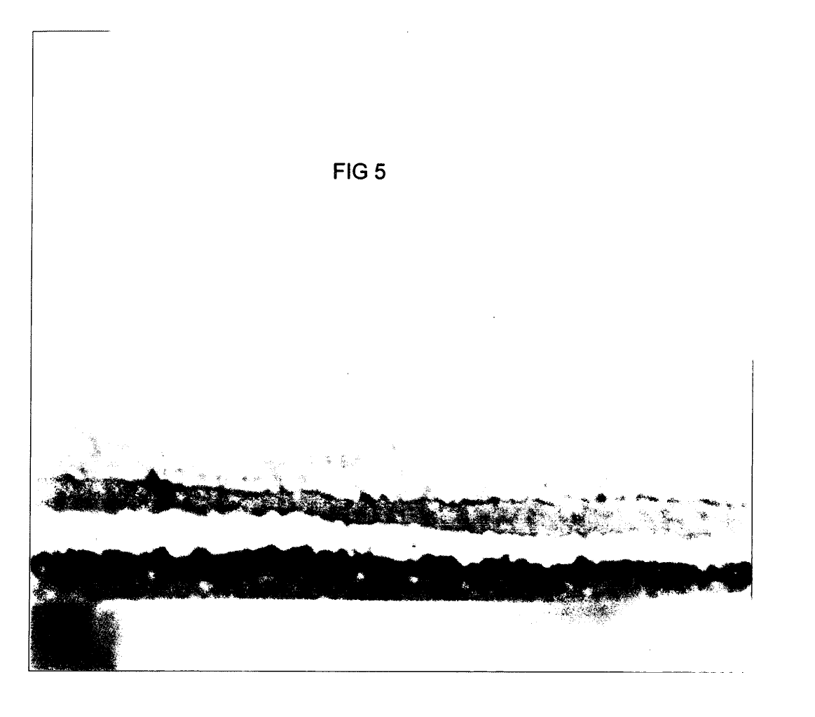

As shown in FIG. 5, the kit enables six, respectively, differently colored continuous layers to be deposited successively onto the gel layer.

In the fifth embodiment of formicarium, the regions of differently colored sands are located in different volumes of the housing but do not form layers extending across the entire width of the housing. In this embodiment, a bottom layer of gel is omitted entirely, reliance for ant nutrition (and sand binding) being placed on sugar residue from a solution in water poured over the sand and allowed to dry.

It should be noted that moisture alone saturating the sand may form a binder sufficient to permit some tunneling, at least until the moisture evaporates. When water has evaporated from a sugar solution saturating the sand, the sugar residue binds the individual particles together.

It has been observed that ants have less tendency to tunnel in sand of very bright color, such as pale yellow. It is postulated that individual particles of such sands have smoother, ceramic type, surfaces than corresponding surfaces of more darkly colored sand which renders the sand less susceptible to wetting, (less capillarity), and therefore often insufficiently bound to enable efficient tunneling.

In alternative embodiments, other colored particulates such as beads/articles marked with identifying indicia (including colors) that can be tunneled and excavated by the ants may be utilized instead of sand or differently colored layers of gel or may be distributed in known locations in the sand or gel.

The activities of tunneling/burrowing creatures other than ants may also be tracked, according to the invention.

1. A formicarium comprising an ant proof housing with a transparent side wall portion and partially filled with differently colored, ant tunneling material, which forms contiguous regions of respectively different colors so that ants can tunnel through the material depositing tailing layers of different colors on a top surface of the material in an order corresponding to an order of the regions in which the ants have been tunneling and seen through the transparent side wall portion.

2. The formicarium of claim 1 wherein the regions having different colors from each other are formed as respective distinct layers extending horizontally at respective different levels.

3. The formicarium of claim 1 wherein the ant tunneling material comprises sand and a binder which binds sand particles sufficiently for ant tunneling.

4. The formicarium of claim 2 wherein the ant tunneling material comprises sand and a binder which binds sand particles sufficiently for ant tunneling.

5. The formicarium of claim 2 wherein an ant food is provided in the housing.

6. The formicarium of claim 3 wherein, the binder comprises an ant food.

7. The formicarium of claim 4 wherein, the binder comprises an ant food.

8. The formicarium of claim 2 wherein, the ant food comprises a layer of ant nutritious gel on the bottom of the housing.

9. The formicarium of claim 6 wherein, the ant food comprises sugar.

10. The formicarium of claim 7 wherein, the ant food comprises sugar.

11. A method for making a formicarium comprising the steps of:
providing an ant proof housing with a transparent side wall portion;
providing ant tunneling material of respectively different colors;
depositing the ant tunneling material in the housing to form contiguous regions of respectively different colors, so that ants can tunnel through the regions depositing tailing layers of different colors on a top surface of the material in an order corresponding to an order of the regions in which the ants have been tunneling and and seen through the transparent side wall portion.

12. The method of claim 11 wherein the contiguous regions having different colors from each other are deposited as respective distinct layers extending horizontally at respective different levels.

13. The method of claim 11 wherein the ant tunneling material comprises sand and a binder added to the sand after deposition thereof as contiguous regions to bind sand particles sufficiently for tunneling.

14. The method of claim 12 wherein the ant tunneling material comprises sand and a binder added to the sand after deposition thereof as distinct layers to bind sand particles sufficiently for tunneling.

15. The method of claim 13 wherein, the binder comprises an ant food.

16. The method of claim 14 wherein, the binder comprises an ant food.

17. The method of claim 15 wherein the binder comprises sugar residue from a sugar solution which has been poured onto sand in the housing so as saturate sand and permitted to dry out.

18. The method of claim 16 wherein the binder comprises sugar residue from a sugar solution which has been poured onto sand in the housing so as saturate sand and permitted to dry out.

19. A kit for assembling a formicarium comprising an ant proof housing with a transparent side wall portion and a plurality of containers each filled with a supply of ant tunneling material of a different color which a user can empty into the housing to form contiguous regions of ant tunneling material of respectively different colors so that ants can tunnel through the material depositing tailing layers of different colors on a top surface of the material in an order corresponding to an order of regions in which the ants have been tunneling and seen through the transparent side wall portion.

20. The kit of claim 19 wherein the ant tunneling material is sand and a binder by which sand particles are bound sufficiently for tunneling

21. The kit of claim 20 wherein the binder comprises an ant food.

22. The kit of claim 21 wherein the ant food comprises sugar and the kit comprises a cup and a stirrer so that a user can add water and the sugar to the cup and use the stirrer to dissolve the sugar in the water providing the ant nutritious binder and then pour the sugar solution from the cup onto sand in the housing to saturate and bind the sand particles for tunneling.

23. The kit of claim 22 wherein the housing has opposed side walls spaced apart at ant tunnel width at least one of which side walls comprises the transparent side wall portion and the particulate material is sand.

24. The kit of claim 19 wherein a bottom layer of ant nutritious gel is provided in the housing.

25. A method for tracking ant tunneling activity comprising the steps of:
providing an ant proof housing with a transparent side wall portion;
providing portions of ant tunneling material of respectively different colors;
depositing the portions of ant tunneling material in the housing to form respective contiguous regions of respectively different colors, so that ants tunneling through the regions deposit tailing layers of different colors on a top surface of the material in an order corresponding to an order of the regions in which the ants have been tunneling as seen through the transparent side wall portion and,
viewing the tunneling material through the side wall portion and tracking the order in which the tailings have been deposited on the top surface of the tunneling material.
